(19) United States
(12) Patent Application Publication
(10) Pub. No.: US 2014/0036615 A1
(43) Pub. Date: Feb. 6, 2014

(54) MEDICINE STIRRING APPARATUS AND MEDICINE STIRRING METHOD

(71) Applicant: Panasonic Corporation, Osaka (JP)

(72) Inventors: Akinobu OKUDA, Nara (JP); Yuki TAKENAKA, Osaka (JP)

(73) Assignee: Panasonic Corporation, Osaka (JP)

(21) Appl. No.: 13/956,784

(22) Filed: Aug. 1, 2013

(30) Foreign Application Priority Data
Aug. 2, 2012 (JP) 2012-171586
Jul. 10, 2013 (JP) 2013-144260

(51) Int. Cl. B01F 11/00

(52) U.S. Cl. CPC B01F 11/0025
USPC 366/114

(57) ABSTRACT

A stirring apparatus includes a container support section supporting a medicine container, a rotational driving section rotating the medicine container supported by the container support section around a central axis of the medicine container, a vibration driving section reciprocal vibrating the medicine container supported by the container support section along the central axis of the medicine container, pressing rollers arranged opposed to the container support section, the pressing rollers pressing the medicine container across the medicine container between the pressing rollers and the container support section, and a control part controlling the rotational driving section and the vibration driving section. The pressing rollers are diagonally arranged.

### BACKGROUND OF THE INVENTION

The present invention relates to a medicine stirring apparatus and a medicine stirring method for stirring a plurality of medicines.

In hospitals and the like a powder medicine may be dissolved and then mixed in a liquid medicine and, the mixture may be prescribed to an inpatient. In mixing medicines, a pharmacist or a nurse stirs a bottle containing the powder medicine and the liquid medicine to dissolve the medicines. Examples of such medicine stirring method include turning the bottle upside down (inverted mixing), shaking the bottle along its central axis (strong shaking), and circling the bottle around a lid of the bottle (preparation). Herein, operators such as the pharmacist and the nurse are referred to as an operator.

However, such operation often takes long time, placing a large load on the operator. Further, depending on the type of medicines, the medicine cannot be evenly stirred, or foam generation may occur at stirring.

There is proposed a stirring apparatus for evenly stirring a powder medicine and a liquid medicine while defoaming, and reducing a load on the operator (Refer to, for example, Patent Literature 1). FIG. 11 is a perspective view showing a conventional stirring apparatus in its entirety.

The stirring apparatus shown in FIG. 11 has vibrators 2 at each of four corners of a lower surface of an upper base 1. The upper base 1 is vertically vibrated along an arrow in FIG. 11 by the vibrators 2. A hoop 3 arranged at the center of the upper base 1 rotates at a predetermined rate. The hoop 3 is arranged in a space sealed by the upper base 1 and a tank 5.

A container 7 containing powder and liquid is set to the hoop 3 and then, a paddle 7a is set to the container 7. By rotating the hoop 3, the container 7 on the hoop 3 rotates with respect to the static paddle 7a, stirring the powder and the liquid in the container 7. By vertically vibrating the container 7 with the vibrators 2 at the same time, the powder and the liquid are stirred more evenly.

As described above, it is alleged that the conventional stirring apparatus shown in FIG. 11 can stir powder and liquid more evenly.

### Citation List

Patent Literature
Patent Literature 1: Japanese Unexamined Patent Publication No. 62-286527

However, the stirring apparatus disclosed in Patent Literature 1 requires a dedicated container for stirring. Since transfer of medicines from a medicine container to the dedicated container put a load on the operator, it is desired to stir medicines in the medicine container without transfer. However, there are a lot of types of medicine containers of different size and shape. Thus, when the medicine container is set to the stirring apparatus to start stirring, the medicine container vibrates, possibly generating foam.

The present invention is to solve the problem, and an object thereof is to provide a medicine stirring apparatus and a medicine stirring method capable of stirring medicines while suppressing foaming of medicines.

### SUMMARY OF THE INVENTION

To attain the object, a medicine stirring apparatus according to one aspect of the present invention is characterized by comprising:

a container support section supporting a medicine container;

a rotational driving section rotating the medicine container supported by the container support section around a central axis of the medicine container via the container support section;

a vibration driving section reciprocal vibrating the medicine container supported by the container support section along the central axis of the medicine container via the container support section;

a pressing roller arranged opposed to the container support section, the pressing roller pressing the medicine container across the medicine container between the pressing roller and the container support section; and

a control part independently controlling driving of the rotational driving section and the vibration driving section, wherein

the pressing roller is diagonally arranged with respect to the central axis of the medicine container supported by the container support section.

To attain the object, a medicine stirring method according to one aspect of the present invention is characterized by comprising:

rotating a medicine container around a central axis of the medicine container with a rotational driving section via a container support section under control of a control part with the medicine container sandwiched between the container support section and a diagonally-arranged pressing roller; and

reciprocatingly vibrating the medicine container along the central axis with a vibration driving section via the container support section.

According to the aspects of the present invention, medicines can be stirred while suppressing foaming of the medicines.

### BRIEF DESCRIPTION OF THE DRAWINGS

These and other objects and features of the present invention will become clear from the following description taken in conjunction with the embodiments thereof with reference to the accompanying drawings, in which:

FIG. 1 is a schematic configuration view of a stirring apparatus in accordance with a first embodiment of the present invention;

FIG. 2A is a plan view of a mechanism section of the stirring apparatus in accordance with the first embodiment of the present invention;

FIG. 2B is a plan view of the mechanism section of the stirring apparatus in accordance with the first embodiment of the present invention when viewed from an arrow A in FIG. 2A;

FIG. 2C is a plan view of the mechanism section of the stirring apparatus in accordance with the first embodiment of the present invention when viewed from an arrow B in FIG. 2A;

FIG. 3 is a view showing an irradiation timing of illumination unit of the stirring apparatus in accordance with the first embodiment of the present invention;

FIG. 4 is a plan view showing the state where medicine containers are arranged in the mechanism section of the stirring apparatus in accordance with the first embodiment of the present invention;

FIG. 5 is a schematic view of the mechanism section of the stirring apparatus in accordance with the first embodiment of the present invention when viewed from the bottom of the medicine container;

FIG. 6A is a partial perspective view of a stirring system in which two sets of the stirring apparatuses in accordance with the first embodiment of the present invention are arranged;

FIG. 6B is a partial plan view of the stirring system in which two sets of the stirring apparatuses in accordance with the first embodiment of the present invention are arranged;

FIG. 6C is a partial front view of the stirring system in which two sets of the stirring apparatuses in accordance with the first embodiment of the present invention are arranged;

FIG. 6D is a partial right side view of the stirring system in which two sets of the stirring apparatuses in accordance with the first embodiment of the present invention are arranged;

FIG. 7A is a schematic plan view of the medicine container supported by a container support section of the stirring apparatus in accordance with the first embodiment of the present invention when viewed from above;

FIG. 7B is a schematic plan view of the medicine container supported by the container support section of the stirring apparatus in accordance with the first embodiment of the present invention when viewed from above;

FIG. 7C is a schematic plan view of the medicine container supported by the container support section of the stirring apparatus in accordance with the first embodiment of the present invention when viewed from above;

FIG. 7D is a schematic plan view of the medicine container supported by the container support section of the stirring apparatus in accordance with the first embodiment of the present invention when viewed from above;

FIG. 8 is a flowchart of a stirring method in accordance with the first embodiment of the present invention;

FIG. 9 is a plan view of a mechanism section of a stirring apparatus in accordance with a second embodiment of the present invention;

FIG. 10A is a plan view of a modification example of pressing rollers of the stirring apparatus in accordance with the first embodiment of the present invention;

FIG. 10B is a plan view of a modification example of the pressing rollers of the stirring apparatus in accordance with the first embodiment of the present invention;

FIG. 10C is a plan view of a modification example of the pressing rollers of the stirring apparatus in accordance with the first embodiment of the present invention;

FIG. 10D is a plan view of a modification example of the pressing rollers of the stirring apparatus in accordance with the first embodiment of the present invention;

FIG. 10E is a plan view of a modification example of the pressing rollers of the stirring apparatus in accordance with the first embodiment of the present invention; and

FIG. 11 is a schematic perspective view of a stirring apparatus according to Patent Literature 1.

### DETAILED DESCRIPTION OF THE EMBODIMENTS

Embodiments of the present invention will be described below with reference of figures. The same constituents are given the same reference numerals, and description thereof may be omitted. For convenience of understanding, the constituents are schematically shown. To clarify the correspondence between the constituents, each of the figures shows XYZ axes as needed.

### First Embodiment

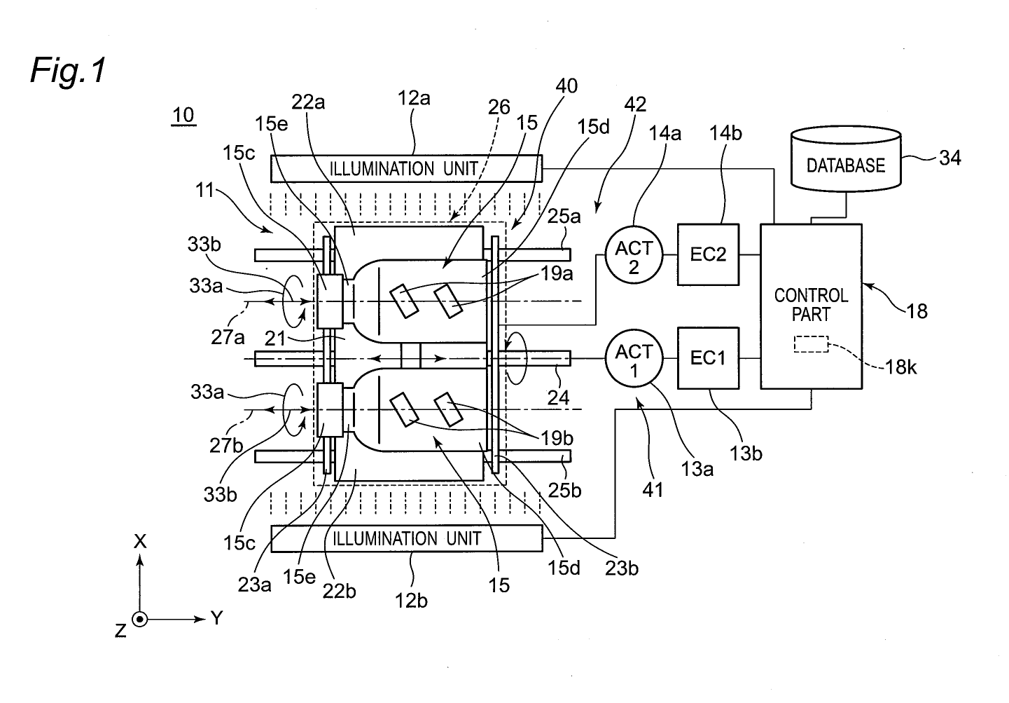

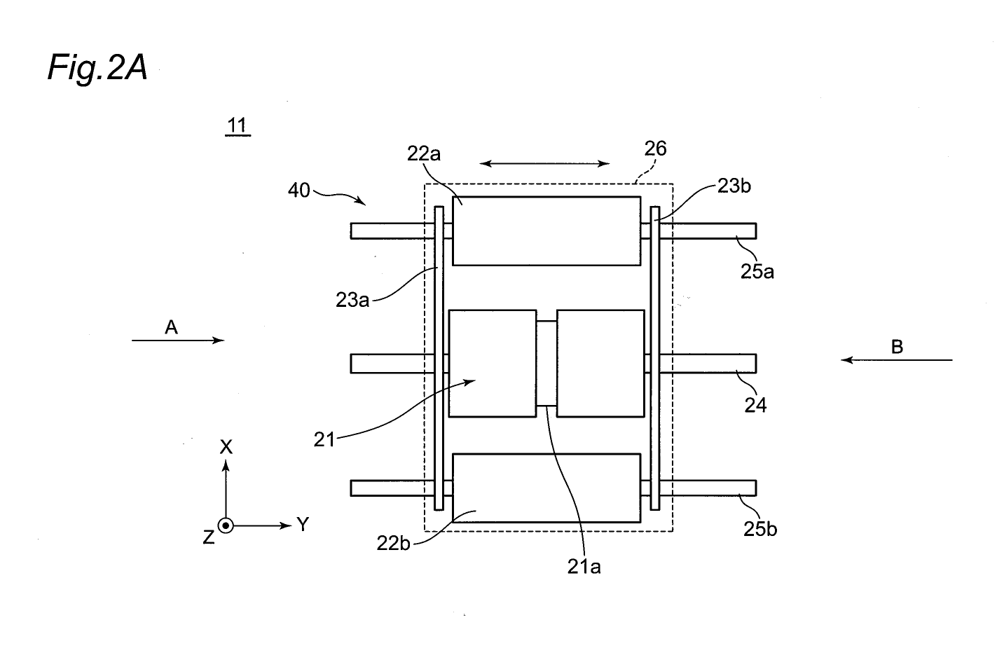

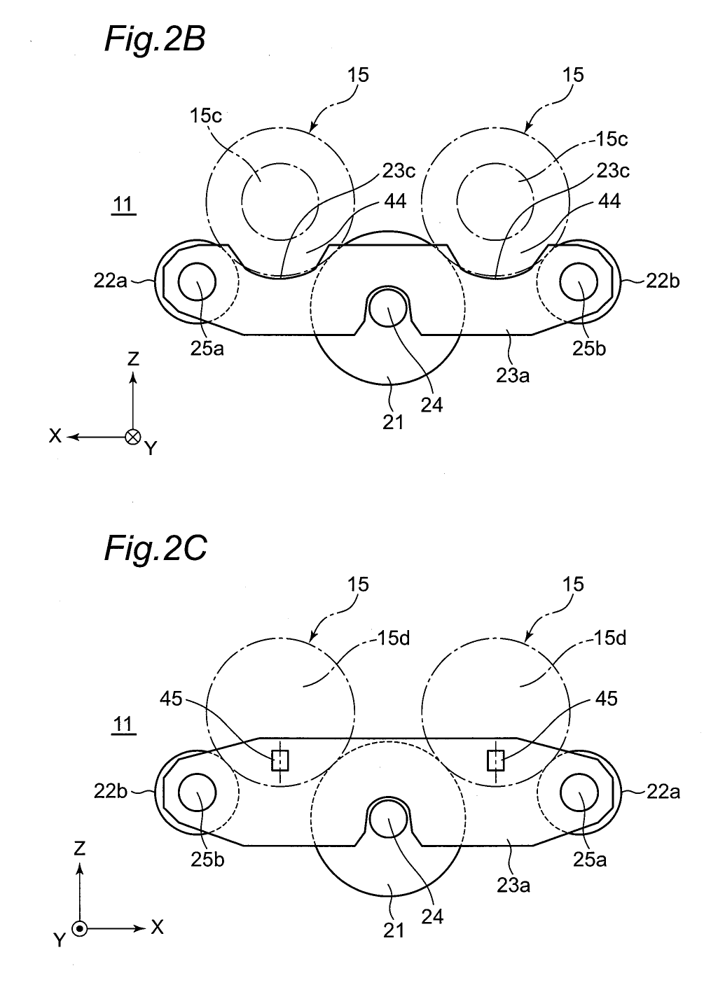

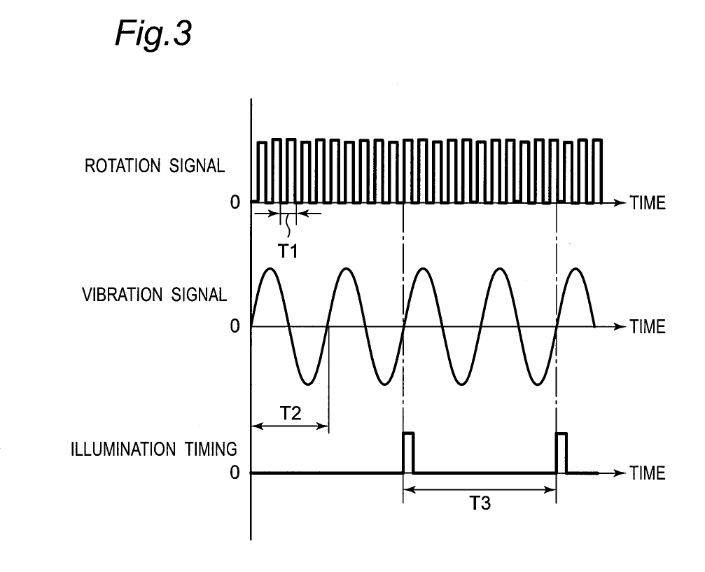

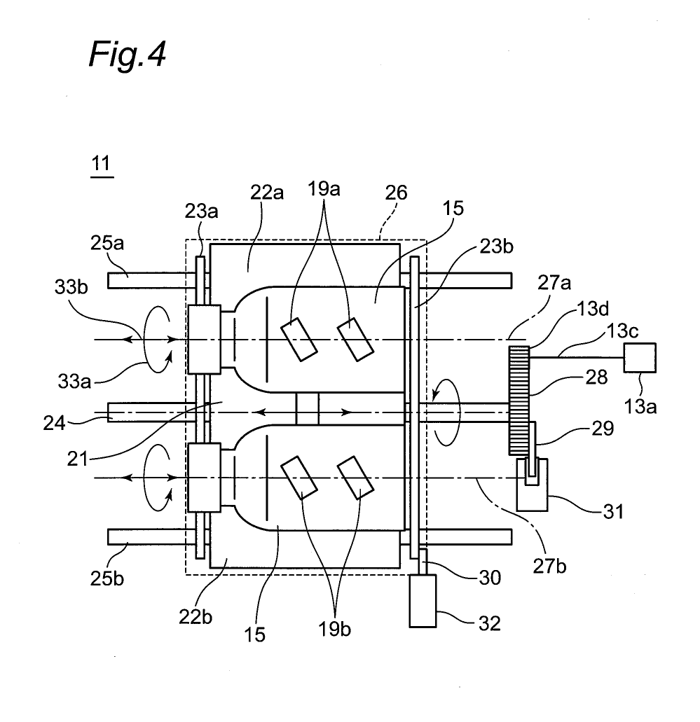

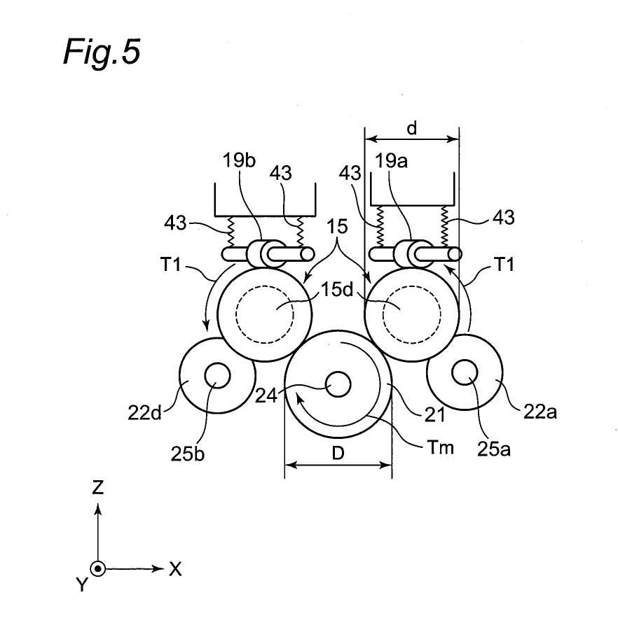

FIG. 1 is a schematic configuration view of a stirring apparatus 10 in accordance with a first embodiment of the present invention. The stirring apparatus 10 in accordance with the first embodiment is an example of a medicine stirring apparatus, and a stirring method using the stirring apparatus is an example of a medicine stirring method. FIG. 2A to FIG. 2C are figures showing a rotational mechanism 11 as a part of the stirring apparatus 10 in accordance with the first embodiment of the present invention, and show the state where a medicine container 15 is removed. FIG. 2A is a plan view of the rotational mechanism 11, FIG. 2B is a view of the rotational mechanism 11 when viewed from an arrow A in FIG. 2A, and FIG. 2C is a view of the rotational mechanism 11 when viewed from an arrow B in FIG. 2A. FIG. 3 is a view showing timings of light irradiation from illumination units 12a and 12b of the stirring apparatus 10 in accordance with the first embodiment of the present invention. FIG. 4 is a plan view showing the state where two columnar medicine containers 15 are arranged in the rotational mechanism 11 as a part of the stirring apparatus 10. FIG. 5 is a schematic side view of the rotational mechanism 11 when viewed from bottoms 15d of the medicine containers 15. As shown in the figures, each of the medicine containers 15 is a general substantially columnar container having a lid 15c and a neck 15e. Thus, in the first embodiment, the medicine container 15 is described as a columnar container. For example, the medicine container 15 is a vial container or a medicine bottle. In the first embodiment, stirring of medicines is an example of mixture of medicines.

As shown in FIG. 1, the stirring apparatus 10 in the first embodiment includes a container support section 40, diagonally arranged pressing rollers 19a and 19b, a rotational driving section 41, a vibration driving section 42, and a control part 18. The stirring apparatus 10 further includes the illumination units 12a and 12b.

The container support section 40 in the first embodiment includes one driving roller 21 and two driven rollers 22a and 22b. The container support section 40 contacts the medicine containers 15 from below, and supports the medicine containers 15 so as to make the medicine containers 15 parallel to each other along respective central axes 27a and 27b.

The pressing rollers 19a and 19b each are formed of a pair of rotatable rollers. As shown in FIG. 5, the pressing rollers 19a and 19b each are biased toward the medicine container 15 by a pair of biasing members 43 such as springs, and contact the medicine container 15 from above to support the medicine container 15. For example, the biasing members 43 are a pair of torsion coil springs attached to both ends of the rotary shaft of each of the pressing rollers 19a and 19b.

The driving roller 21 and the driven rollers 22a and 22b function as the container support section 40 as well as the rotational mechanism 11. Thus, configurations of the driving roller 21 and the driven rollers 22a and 22b will be described later in the description of the rotational mechanism 11.

In the first embodiment, the container support section 40 and the pressing roller 19a support one medicine container 15 in three directions, and the container support section 40 and the pressing roller 19b support one medicine container 15 in three directions. Here, the three directions are spaced at intervals of 120 degrees. Since the two medicine containers 15 are assumed as an object to be supported in the first embodiment, the two driven rollers 22a and 22b and the four pressing rollers 19a and 19b are used. However, depending on the number of medicine containers as an object to be supported, the number of the rollers is appropriately changed. For example, when one medicine container 15 is used as an object to be supported, one driven roller 22a and two pressing rollers 19a may be used.

The pressing rollers 19a and 19b may have irregularities on their surfaces to appropriately adjust frictional forces. In the case where the pressing rollers 19a and 19b can apply sufficient amounts of friction, the pressing rollers 19a and 19b each may be formed of one roller.

The rotational driving section 41 is coupled to the container support section 40, and includes the rotational mechanism 11, a rotary driving actuator 13a, and an encoder 13b for detecting the rotational angle of the rotary driving actuator 13a. The rotary driving actuator 13a is, for example, a motor. The encoder 13b is arranged, for example, at the rotary shaft of the motor to detect the rotational angle of the rotary shaft.

The rotational driving section 41 is coupled to the vibration driving section 42 with coupling plates 23a and 23b supporting the container support section 40.

As shown in FIG. 2A, the rotational mechanism 11 includes the columnar driving roller 21, the driven rollers 22a and 22b, the coupling plates 23a and 23b, the rotary shaft 24 of the driving roller 21, and the rotary shafts 25a and 25b of the driven rollers 22a and 22b. The rotary shaft 24 of the driving roller 21 is arranged parallel to the rotary shafts 25a and 25b of the driven rollers 22a and 22b. These rotary shafts 24, 25a, and 25b are parallel to the central axes 27a and 27b of the medicine container 15. The driving roller 21 is rotatably supported between the lid-side coupling plate 23a of the medicine container 15 and the bottom-side coupling plate 23b of the medicine container 15 via the rotary shaft 24.

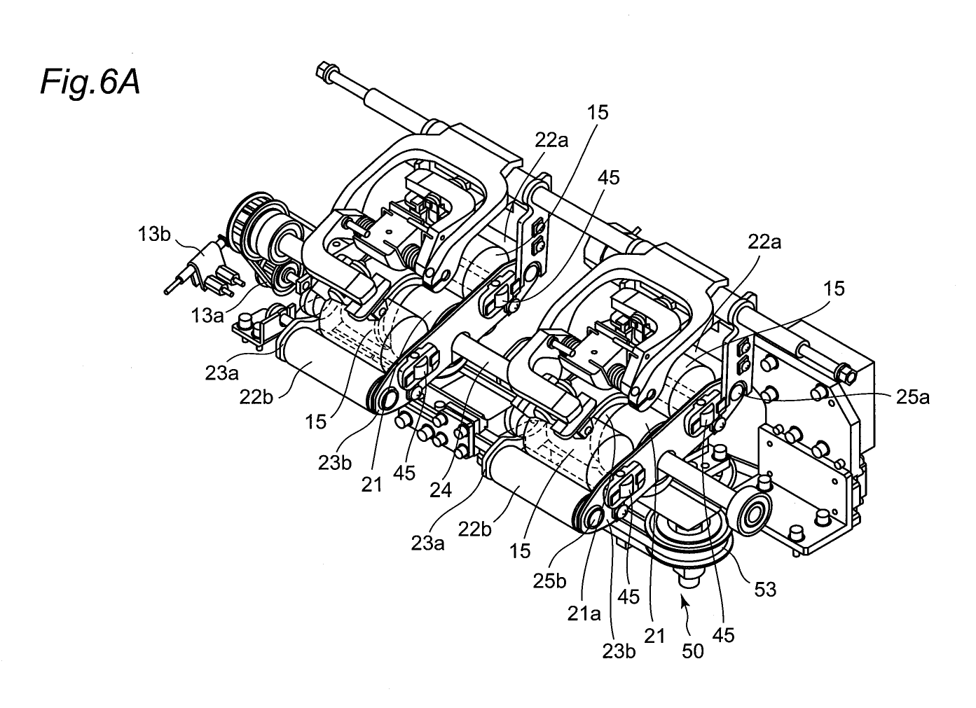

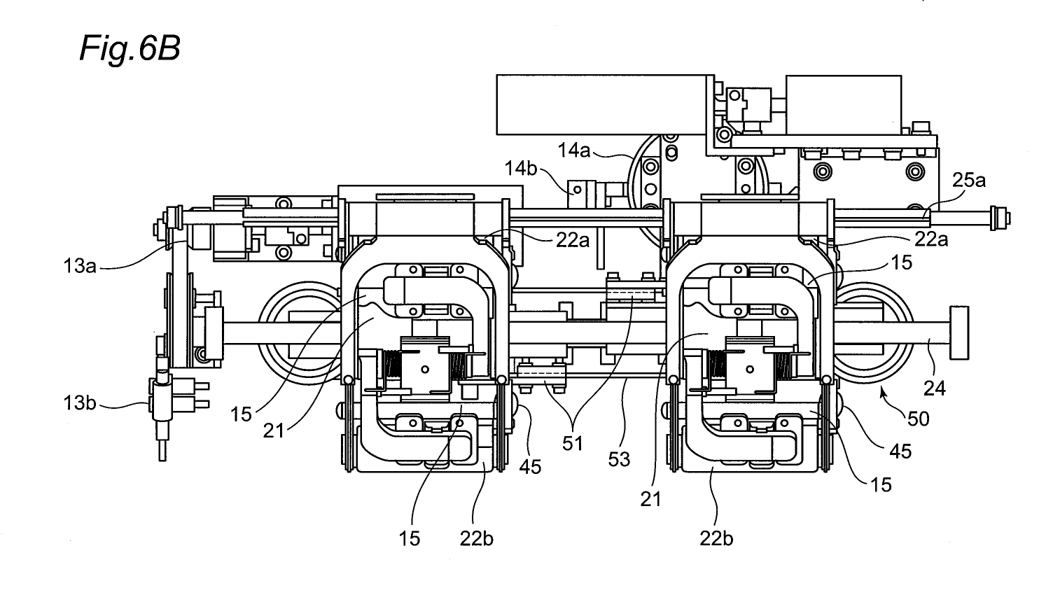

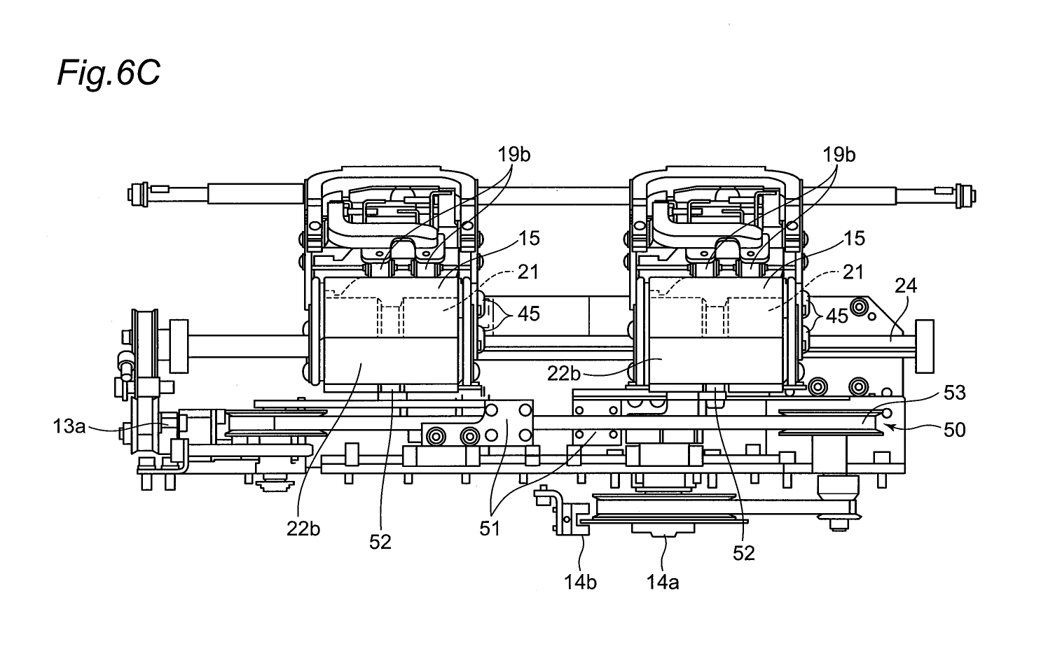

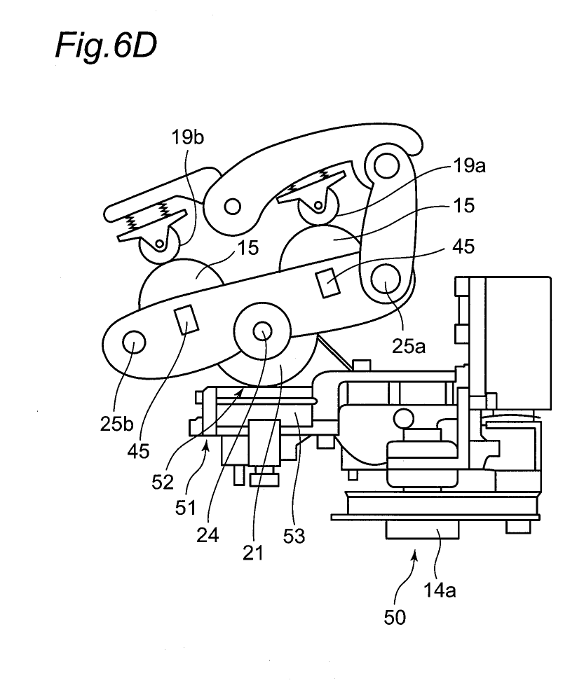

Rotational rollers 45 (refer to FIG. 2C and FIG. 6A to FIG. 6D) are rotatably supported by the bottom-side coupling plate 23b. The rotary shafts of the rotational rollers 45 are orthogonal to the rotary shafts 25a and 25b of the driven rollers 22a and 22b. With such configuration, each of the rotational rollers 45 rotates in contact with the bottom surface of the medicine container 15 to smooth rotation of the medicine container 15, preventing that friction caused by contact between the bottom surface of the medicine container 15 and the bottom-side coupling plate 23b damages the medicine container 15.

The rotary shaft 24 of the driving roller 21 is coupled to the rotary shaft of the rotary driving actuator 13a, thereby rotating the driving roller 21 in a predetermined rotational direction by the rotary driving actuator 13a. The driven rollers 22a and 22b are rotatably supported between the lid-side coupling plate 23a of the medicine container 15 and the bottom-side coupling plate 23b of the medicine container 15 via the rotary shafts 25a and 25b. The driven rollers 22a and 22b each are formed of a columnar roller. When the medicine container 15 is mounted on the driving roller 21 and the driven rollers 22a and 22b, the driving roller 21 and the driven rollers 22a and 22b support the medicine container 15 from below.

In the first embodiment, to restrict position and prevent vibration of the medicine containers 15, the pressing rollers 19a and 19b are diagonally arranged. More specifically, as shown in FIG. 1, the four pressing rollers 19a and 19b are diagonally arranged with respect to the central axes 27a and 27b of the medicine containers 15 (or the rotary shaft 24 of the driving roller 21). More specifically, as shown in FIG. 1, the pressing rollers 19a and 19b are diagonally arranged so as to become closer to the bottom of the medicine containers 15 (closer to the coupling plates 23b) in the direction of rotating the medicine containers 15 supported by the container support section 40. By diagonally arranging the pressing rollers 19a and 19b in this manner, as the medicine containers 15 rotates, friction between the pressing rollers 19a and 19b and the medicine containers 15 generates a force to press the medicine container 15 toward the bottom 15d of the medicine container 15. This can restrict the position of the medicine containers 15.

By using the diagonally-arranged pressing rollers 19a and 19b, as rotation of each of the medicine containers 15, each medicine container 15 is pressed toward the bottom-side coupling plate 23b, restricting the position of the medicine container 15 with the coupling plate 23. As a result, there is no possibility that each medicine container 15 is displaced in the direction of the rotary shafts 25a and 25b to unnecessarily vibrate. Desirably, at least two pressing rollers 19a and 19b are provided for the one medicine container 15. By arranging at least two pressing rollers for the one medicine container 15, the force to bias the medicine container 15 to the bottom is increased. In addition, even when the diameter of the medicine container 15 has an error along the central axes 27a and 27b, the two pressing rollers 19a and 19b can be reliably brought into contact with the outer circumferential surfaces of the respective medicine containers 15 by using an automatic core-adjusting mechanism or the like.

In the first embodiment, in order to generate the frictional force (pressing force) toward the bottoms 15d on the outer circumferential surfaces of the medicine container 15, the pressing rollers 19a and 19b are diagonally arranged. The present inventors' experiment demonstrated that an inclination angle of the pressing rollers 19a and 19b in the range of 3 to 10 degrees generated desirable friction.

As shown in FIG. 2B, two concave sections 23c are provided at positions of the lid-side coupling plate 23a, which correspond to the lids 15c of the two medicine containers 15 supported by the container support section 40. To prevent the lid 15c of the medicine container 15 from contacting and interfering with the lid-side coupling plate 23a, each of the concave sections 23c is provided to form a gap 44 between the lid 15c of the medicine container 15 and the lid-side coupling plate 23a. In the first embodiment, as described above, by using the diagonally arranged pressing rollers 19a and 19b, the pressing force toward the bottom 15d of the medicine container 15 is generated to restrict the position of the medicine containers 15. Thus, arrangement of the medicine containers 15 with respect to the driven rollers 22a and 22b and the pressing rollers 19a and 19b is important. However, the medicine container 15 can have various shapes and sizes and therefore, it is difficult to provide the container support section 40 having the shape completely corresponding to the shape of the medicine container 15. Therefore, in the first embodiment, by providing such concave sections 23c and mounting the lids 15c of the medicine containers 15 on the side of the concave sections 23c by the operator, the position of the medicine containers 15 can be uniquely determined.

As shown in FIG. 4, a driving gear 28 is fixed to one end of the rotary shaft 24 of the driving roller 21. The rotary shaft 24 and the driving gear 28 integrally rotate. The driving gear 28 rotates in engagement with a gear 13d fixed to the rotary shaft 13c of the rotary driving actuator 13a. A jig 29 is diametrically fixed to the driving gear 28, and positional detection is performed each time the jig 29 passes a position detecting section 3l. For detection of the position of the rotary shaft 13c, the encoder 13b, or either the jig 29 or the position detecting section 31 is used.

The vibration driving section 42 is coupled to the container support section 40, and includes a vibration mechanism section 26, an actuator 14a, and an encoder 14b. The vibration driving section 42 causes the medicine containers 15 to reciprocatingly vibrate along the respective central axes 27a and 27b. The actuator 14a is, for example, a motor, and a conversion mechanism for converting rotational motion of the motor into linear reciprocating motion. The encoder 13b is arranged at the rotary shaft of the motor to detect the rotational angle of the rotary shaft. A jig 30 is fixed to the coupling plate 23b, and positional detection is performed each time the jig 30 passes a position detecting section 32.

The jigs 29 and 30 are, for example, position detecting jigs. The position detecting sections 31 and 32 are, for example, transmission photosensors.

The illumination units 12a and 12b apply light toward the medicine containers 15 from at least either below or sides of the medicine containers 15. The reason why light is applied from such direction toward the medicine containers 15 is that the operator (a pharmacist, a nurse or the like) can visually and easily check the medicine containers 15 and their insides from above the stirring apparatus 10. In the first embodiment, the operator visually checks the medicine containers 15 or their insides from above, but the present invention is not limited to this. For example, in the case of visual check from sides, the illumination units 12a and 12b can apply light to the medicine containers 15 from at least either from opposed surfaces or upper and lower sides, achieving the same effects. The illumination units 12a and 12b are, for example, LED illuminations. When the LED illuminations are used as the illumination units 12a and 12b, light of specific wavelength (wavelength that hardly transform medicines) can be applied to even medicines easily transformed due to light. The LED illumination generates less heat than other light sources, and is less likely to cause medicine transformation due to heat.

A rotation signal and a vibration signal in FIG. 3 are acquired by any of following signal acquisition methods. The first signal acquisition method acquires the rotation signals and the vibration signals by using the encoder 13b of the rotary driving actuator 13a and the encoder 14b of the vibration driving actuator 14a in FIG. 1. The second signal acquisition method acquires the rotation signals and the vibration signals by using the jig 29 on the driving gear 28 of the rotational mechanism 11, the jig 30 on the coupling plate 23b of the vibration mechanism section 26, and the position detecting sections 31 and 32 in FIG. 4. A rotation cycle T1 and a vibration cycle T2 can be acquired from the rotating encoder 13b for rotation driving and the vibrating encoder 14b for vibration driving, respectively, or from the position detecting sections 31 and 32 provided near the rotational mechanism 11 and the vibration mechanism section 26, respectively. The cycles T1 and T2 converted from the outer diameter of the medicine container 15 can be calculated by a calculating part of the control part 18. Specifically, based on a mechanism rotation cycle Tm at which the rotary shaft 24 rotates, the rotation cycle T1 of the medicine container 15 can be calculated by the calculating part of the control part 18 according to an equation: T1=Tm×(D/d), wherein “D” is an outer diameter of the driving roller 21 of the rotational mechanism 11 and “d” is an outer diameter of the medicine container 15.

In the first embodiment, the control part 18 may previously find a least common multiple cycle T3 of the rotation cycle T1 in which the rotational mechanism 11 rotates the medicine containers 15 and the vibration cycle T2 in which the vibration mechanism section 26 reciprocatingly vibrates the medicine containers 15. The control part 18 can control the timing at which light from the illumination units 12a and 12b is applied to the medicine containers 15, in a cycle that is an integral multiple of the least common multiple cycle T3, so that the rotating and vibrating medicine containers 15 can be observed as if the containers are stationary at the same position and in the same state. As a result, for the stirring apparatus 10 of the first embodiment, the operator can confirm the stirring state of medicines (not shown) in the medicine containers 15 in real time without stopping the operation of the medicine containers 15. Accordingly, each time the operator observes the stirring state (dissolving state) of medicines in the medicine containers 15, it is no need to stop the operation of the stirring apparatus 10. That is, the operator can observe the inside of the medicine container 15 while continuing the operation of the stirring apparatus 10 until stirring is completely finished. Thus, the stirring apparatus 10 in accordance with the first embodiment can efficiently stir medicines in a short time without putting a load on the operator.

Next, overall configuration and basic operations of the stirring apparatus 10 in the first embodiment will be described.

The rotational mechanism 11 causes the rotary driving actuator 13a to rotate the rotary shaft 24 in a predetermined direction, rotating the driving roller 21 coupled to the rotary shaft 24 in the rotational direction. The rotary shaft 24 is, for example, a ball spline. The driving roller 21 can freely move in the axial direction irrespective to rotation or stoppage of the rotary shaft 24. As shown in FIG. 1, when the driving roller 21 rotates in the state where the medicine containers 15 are supported by the container support section 40, the medicine containers 15 rotate with rotation of the driving roller 21, and the driven rollers 22a and 22b supporting the medicine containers 15 from below and the pressing rollers 19a and 19b supporting the medicine containers 15 from above also rotate with rotation of the medicine containers 15. Each of surfaces of the driving roller 21, the driven rollers 22a and 22b, and the pressing rollers 19a and 19b are made of a rubber material such as silicone, which has a large static friction force. By making the driving roller 21, the driven rollers 22a and 22b, and the pressing rollers 19a and 19b from the rubber material having a large static friction force, sliding between the medicine containers 15 and each of the rollers can be prevented. By using a rubber material having resistance to medicines such as anhydrous ethanol, sodium hypochlorite, sodium hydroxide, sodium thiosulfate, which is used at cleaning the stirring apparatus 10, deterioration of the rollers is prevented.

As shown in FIG. 1, FIG. 2A, and FIG. 6A to FIG. 6D, the vibration mechanism section 26 is formed of a belt mechanism section 50 that reciprocatingly vibrates the container support section 40 in a vibration direction 33b by using a groove 21a of the driving roller 21. The belt mechanism section 50 includes a member 51 for converting the rotational motion of the vibration driving actuator 14a into the linear reciprocating motion via a belt 53 and a mechanism 52 for coupling the driving roller 21. The belt mechanism section 50 reciprocatingly vibrates the driving roller 21. In the first embodiment, a plane cam mechanism is used as an example of a mechanism for converting the rotational motion of the vibration driving actuator 14a into the linear reciprocating motion. FIG. 6A to FIG. 6D show a part of a stirring system in which two sets of medicine stirring apparatuses in FIG. 1 are arranged side by side. The stirring system in the first embodiment is an example of a medicine stirring system.

In the first embodiment, the belt mechanism section 50 is used as an example of the vibration mechanism section 26. However, this is an only example, and the present invention is not limited to this, and any mechanism or device that can apply the linear reciprocating motion to the medicine containers 15, such as a pneumatic cylinder, may be adopted.

The container support section 40 is comprised by rotatably integrating the driving roller 21 and the driven rollers 22a and 22b with the coupling plates 23a and 23b. By configuring the container support section 40 in this manner, the driving roller 21 and the driven rollers 22a and 22b can be reciprocatingly vibrated in the vibration direction 33b in an integral manner by use of the vibration mechanism section 26.

In the stirring apparatus 10 in the first embodiment, as shown in FIG. 1 and FIG. 4, the medicine containers 15 are supported by the container support section 40 such that the central axes 2 7a and 27b of the medicine containers 15 are arranged along the horizontal direction. By arranging the central axes 27a and 27b of the medicine containers 15 along the horizontal direction, the medicine containers 15 can be safely supported, and stable rotation and reciprocating vibration with reduced effect of gravity can be achieved.

Based on output signals from the encoders 13b and 14b, the control part 18 electrically controls driving of the actuators 13a and 14a. To correctly control driving of the actuators 13a and 14a according to a medicine to be stirred, the control part 18 acquires information on a medicine 15b in the medicine containers 15 from the database 34 as needed. The information on the medicine 15b is, for example, solubility or foamability of the medicine. The control part 18 controls the illumination units 12a and 12b that irradiate the medicine containers 15 with light, enabling stroboscopic illumination in synchronization with the rotational mechanism 11. The database 34 is, for example, medical information database that stores medical information.

In the stirring apparatus 10 in the first embodiment, first, the control part 18 finds the least common multiple cycle T3 of the rotation cycle T1 in which the rotational mechanism 11 rotates the medicine containers 15 and the vibration cycle T2 in which the vibration mechanism section 26 reciprocatingly vibrates the medicine containers 15. Next, the control part 18 controls the illumination units 12a and 12b such that the medicine containers 15 are irradiated with light in synchronization with time that is an integral multiple of the least common multiple cycle T3.

For example, it is assumed that two vial containers each having a diameter in the range of 30 mm to 45 mm and a length of 80 mm or less are used as the medicine containers 15. The two medicine containers 15 are supported by the container support section 40, are rotated around the central axes 27a and 27b at 1200 rpm by the rotational mechanism 11, and at the same time, the two medicine containers 15 are reciprocatingly vibrated along the central axes 27a and 27b with a vibration stroke of 50 mm and a vibrating frequency of 2 Hz by the vibration mechanism section 26. In this case, in the first embodiment, the control part 18 controls the illumination units 12a and 12b such that medicine containers 15 are irradiated with light in a cycle that is an integral multiple of the least common multiple cycle T3=0.5 sec (least common multiple of the rotation cycle T1=60/1200=0.05 sec and the vibration cycle T2=½=0.5 sec). By controlling the illumination units 12a and 12b so as to apply light in the least common multiple cycle T3, the operator can apparently confirm the state of medicines by visual check or with an imaging camera as if the medicine containers 15 are stationary at the same position and in the same state. Desirably, the illumination units 12a and 12b radiate light instantaneously (stroboscopically).

Given that a solution is added to an anticancer medicine (for example, cyclophosphamide powders) in the medicine container 15 and the mixture is stirred, the stirring apparatus 10 in the first embodiment can stir the mixture in the state where a gaseous layer and a liquid layer in the medicine container 15 are separated from each other within five minutes without generating bubbles, which would take five minutes or more for the operator to manually shake the medicine container 15 200 times per minute. The stirring of 200 times/minute for five minutes is a tough requirement for the operator. In addition, such manual stirring easily generates bubbles in the medicine. Thus, the stirring apparatus 10 in the first embodiment is especially effective for stirring of anticancer medicines or the like.

The control part 18 may read a barcode or the like printed on a label stuck to the outer circumferential surface of the medicine container 15, with a barcode reader (not shown), thereby acquiring information on the outer diameter “d” of the medicine container 15 from the database 34 connected to the control part 18. With such configuration, uniform management and errorless acquisition of information can be easily achieved.

The control part 18 in the first embodiment of the present invention has an adjusting part 18k for the operator to manually fine-tuning the rotation cycle of the rotational mechanism 11. The operator can input a command to adjust the rotation cycle to the adjusting part 18k, causing the adjusting part 18k to adjust the rotation cycle of the rotational mechanism 11 to change the rotation cycle of the medicine container 15, in turn, resulting in changing the timing at which a medicine label 15a on the surface of the medicine container 15 is observed. By changing the rotation cycle in this manner, the operator synchronizes a region where the medicine label 15a is not stuck with the observation timing, readily observing the stirring state in the medicine container 15.

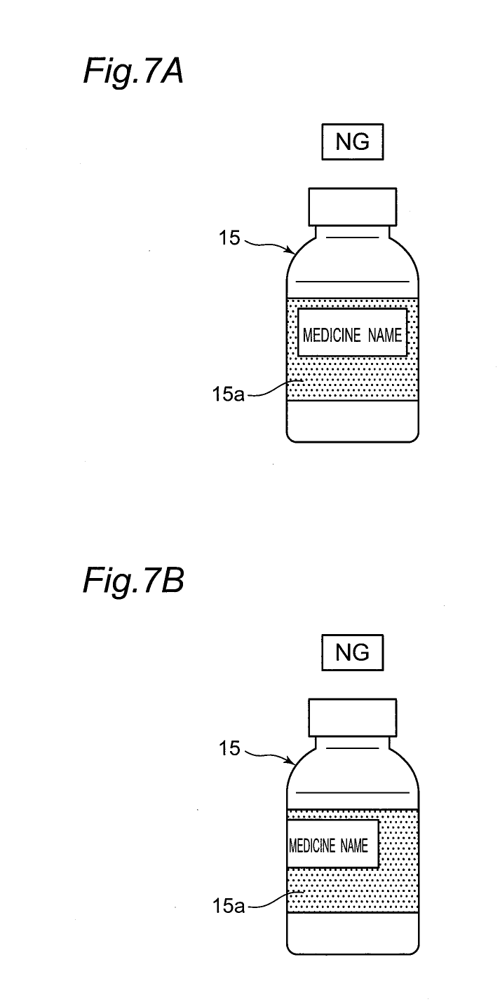

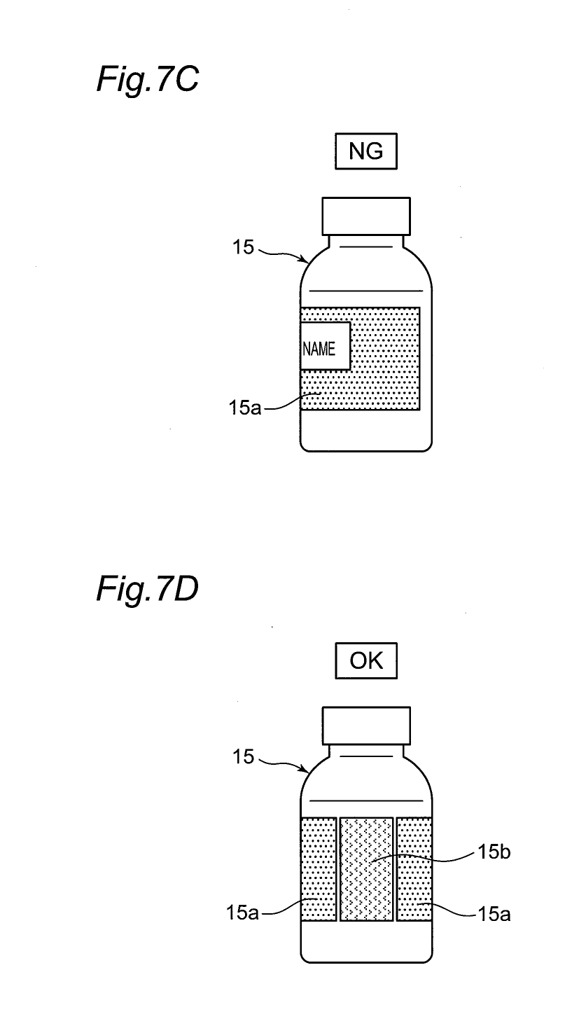

FIG. 7A to FIG. 7D are schematic plan views of the medicine container 15 supported by the container support section 40 of the stirring apparatus 10 in accordance with the first embodiment of the present invention when viewed from above. FIG. 7A to FIG. 7D show the state where the appearance of the medicine label 15a on the medicine container 15 is changed by adjusting the rotation cycle of the rotational mechanism 11 with the adjusting part 18k of the control part 18 shown in FIG. 1.

It is supposed that when the stirring apparatus 10 simultaneously rotates and vibrates the medicine container 15 to start stirring, as shown in a first state in FIG. 7A, only the medicine label 15a is viewable from above. At this time, the control part 18 controls the illumination units 12a and 12b such that the medicine containers 15 are irradiated with light in a cycle that is an integral multiple of the least common multiple cycle T3. In this first state, the operator can view the medicine label 15a, and cannot view the medicine stirring state in the region of the medicine label 15a on the medicine container 15. Thus, for example, the operator inputs a command to adjust the rotation cycle to the adjusting part 18k to adjust the rotation cycle of the rotational mechanism 11 such that a second state in FIG. 7B changes to a fourth state in FIG. 7D through a third state in FIG. 7C. In the fourth state in FIG. 7D, the operator can observe the stirring state of the medicine 15b through a gap of the medicine label 15a, and visually observe the stirring state of the medicine 15b in the medicine container 15 through the surface of the medicine container 15 at the gap of the medicine label 15a in real time. By adjusting the rotation cycle with the adjusting part 18k to manually change the rotation cycle T1 of the medicine container 15 in this manner, the position of the medicine container 15 in the rotational direction can be adjusted. As a result, the operator can change the rotation cycle such that the region where the medicine label 15a is not stuck (the gap of the medicine label 15a) can be observed, thereby observing the state of the medicine 15b stirred in the medicine container 15. The rotation cycle T1 maybe changed automatically, not manually. In the case of automatically changing the rotation cycle T1, an initial condition of the rotation cycle. T1 of the medicine container 15 is changed, but the difference is small and hardly affects the stirring state. In the first embodiment of the present invention, the state for observing the medicine label 15a on the surface of the medicine container 15 is changed by adjusting the rotation cycle T1 of the medicine container 15 and however, the present invention is not limited to this. For example, the same effect can be achieved by changing the irradiation timing while maintaining the irradiation cycle of light from the illumination units 12a and 12b.

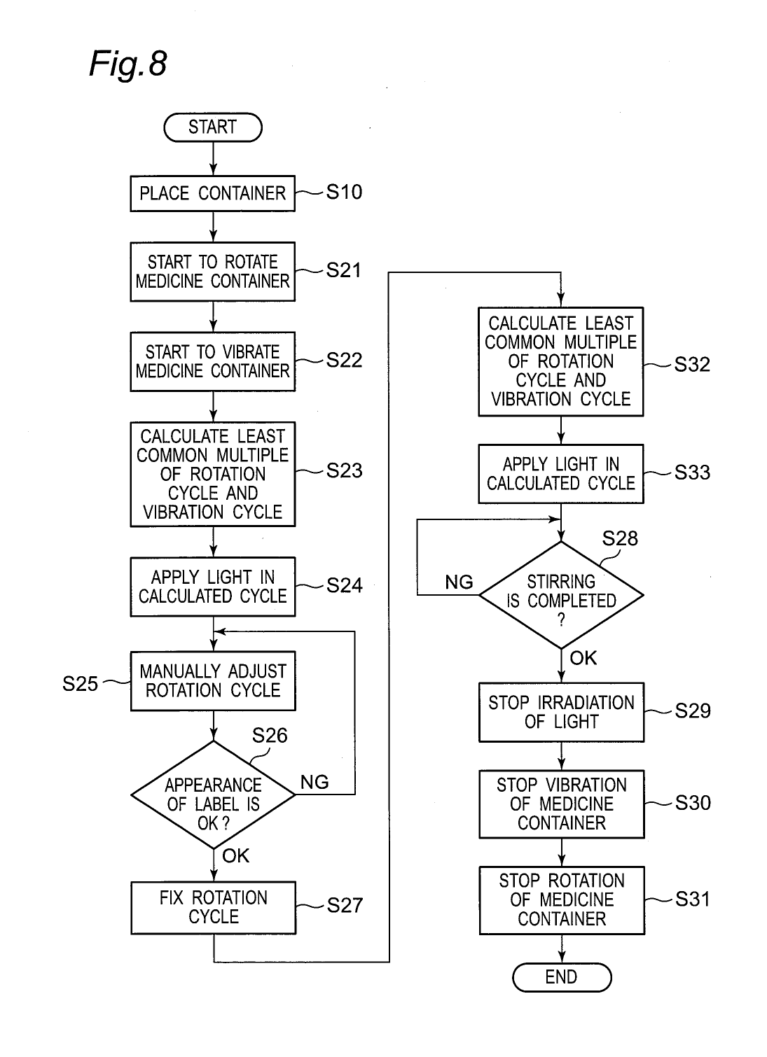

Next, a flowchart of a stirring method in accordance with the first embodiment of the present invention will be described. FIG. 8 is a flowchart showing the stirring method and recognizing method in accordance with the first embodiment of the present invention.

As shown in FIG. 8, according to the stirring method in the first embodiment, first, the medicine containers 15 are placed at the container support section 40 (step S10).

Next, under control of the control part 18, the rotational driving section 41 starts to rotate the medicine containers 15 around their central axes 27a and 27b (step S21).

Next, under control of the control part 18, in the state where the rotational driving section 41 rotates the medicine containers 15, the vibration driving section 42 further reciprocatingly starts to vibrate the medicine containers 15 (perform linear reciprocating motion along the central axes 27a and 27b) (step S22).

Next, the position detecting sections 31 and 32 detect the rotation cycle T1 and the vibration cycle T2 of the medicine containers 15, and the calculating part of the control part 18 calculates the least common multiple cycle T3 (step S23). The control part 18 controls the illumination units 12a and 12b such that the medicine containers 15 are irradiated with light in a cycle that is an integral multiple of the calculated least common multiple cycle T3 (step S24).

Next, the operator manually operates the adjusting part 18k while viewing the position of the medicine labels 15a of the surfaces of the medicine containers 15 (in other words, inputs a command to adjust the rotation cycle to the adjusting part 18k) to adjust the rotation cycle T1 (step S25).

When the medicine 15b in the medicine container 15 is viewable through a gap of the medicine label 15a on the medicine container 15 as shown in FIG. 7D (OK in step S26), the rotation cycle is fixed (in other words, the command to adjust the rotation cycle, which is inputted to the adjusting part 18k, is maintained) (step S27).

In states other than the states shown in FIG. 7A to FIG. 7C in step S26 (NG in step S26), the procedure returns to step S25, and the rotation cycle T1 is manually adjusted. When adjustment of the rotation cycle T1 is finished, the rotation cycle T1 is fixed (in other words, the command to adjust the rotation cycle, which is inputted to the adjusting part 18k, is maintained) (step S27).

Next, the calculating part of the control part 18 recalculates the least common multiple cycle T3 (step S32).

Next, the control part 18 controls the illumination units 12a and 12b such that the medicine containers 15 are irradiated with light in a cycle that is an integral multiple of the recalculated least common multiple cycle T3 (step S33).

Next, while the control part 18 controls the illumination units 12a and 12b to radiate light, the operator continues to stir the medicine 15b while checking the stirring state of the medicine 15b by visual check or with an imaging camera. When stirring (dissolution) is completed (OK in step S28), the operator causes the control part 18 to stop irradiation of light from the illumination units 12a and 12b to the medicine containers 15 (step S29).

Next, the control part 18 stops driving of the vibration driving section 42 to stop reciprocating vibration of the medicine containers 15 (step S30), and finally, stops driving of the rotational driving section 41 to stop rotation of the medicine containers 15 (step S31), thereby finishing a series of stirring operations.

In the first embodiment of the present invention, it is mainly described that the stirring state of the medicine 15b in the medicine containers 15 is visually checked, and however, the present invention is not limited to this, and may address the check with the imaging camera as partially described above. In this case, the control part 18 needs to synchronize a timing at which the medicine containers 15 are irradiated with light, with a timing at which the imaging camera captures an image.

Further, the stirring apparatus 10 in the first embodiment, at stirring of the medicine containers 15 supported by the container support section 40, can suppress unnecessary vibration of the medicine containers 15 to prevent foaming of medicines.

### Second Embodiment

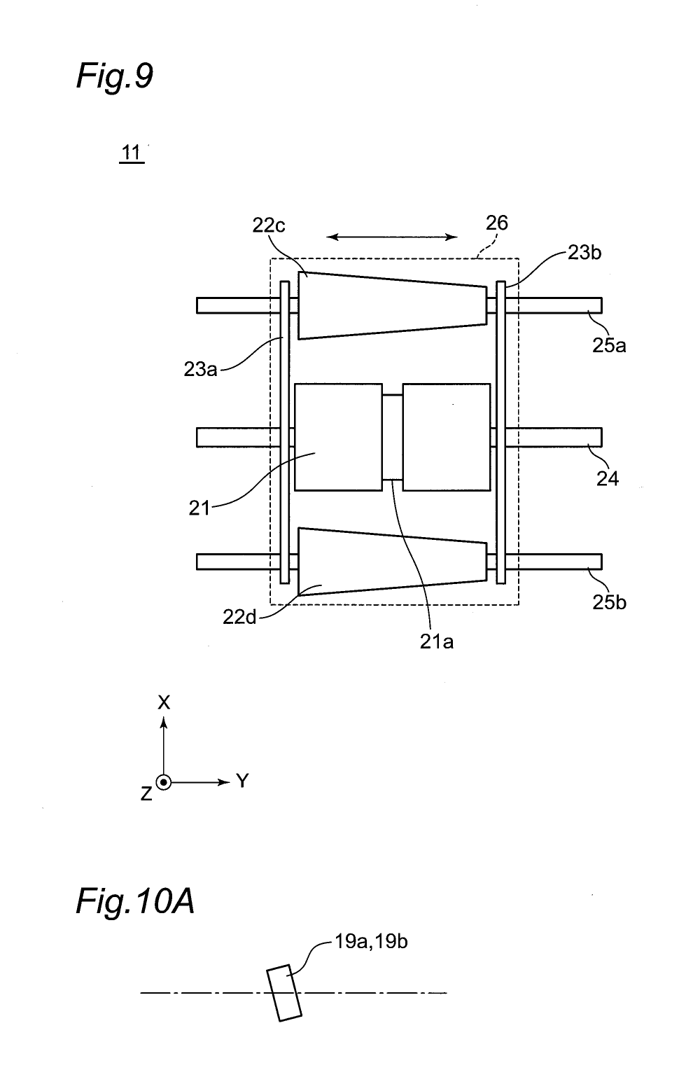

In a second embodiment of the present invention, as shown in FIG. 9, each of driven rollers 22c and 22d are conical rather than columnar in FIG. 1. This embodiment is the same as the first embodiment except for the shape of the driven rollers 22c and 22d and thus, description of the same portions is omitted. With such configuration, desirably, the driven rollers 22c and 22d each have the outer diameter that becomes smaller toward the bottom 15d of the medicine container 15 supported by the container support section 40. That is, in each of the conical driven rollers 22c and 22d, a portion having the larger outer diameter is located adjacent to the lid-side coupling plate 23a of the medicine container 15, and a portion having the smaller outer diameter is located adjacent to the bottom-side coupling plate 23b of the medicine container 15. The rotary shafts 25a and 25b of the driven rollers 22c and 22d are arranged parallel to the rotary shaft 24 of the driving roller 21. By using such driven rollers 22c and 22d, the medicine containers 15 are further pressed toward the bottom-side coupling plate 23b, restricting the position of the medicine containers 15 to prevent the medicine containers 15 from unnecessarily vibrating in the direction of the rotary shafts 25a and 25b.

In the second embodiment, by using the conical driven rollers 22c and 22d in addition to the above-mentioned diagonally-arranged pressing rollers 19a and 19b, a further pressing force toward the bottoms 15d of the medicine containers 15 is generated to restrict the position of the medicine containers 15.

The medicine container 15 may be variously dimensioned and shaped. In the second embodiment, to appropriately address with the various medicine containers 15, the driven rollers 22c and 22d are conical. The present inventors' experiment demonstrated that, in terms of positional restriction and vibration prevention, the desirable inclination angle of the driven rollers 22c and 22d each having a length of 5.8 cm was 0.5 degree or more and 5 degrees or less.

It is assumed to use, in place of the conical driven rollers 22c and 22d, cylindrical driven rollers inclined as in the conical driven rollers. In the case of using the cylindrical driven rollers, the rotary shafts 25a and 25b of the cylindrical driven rollers are not parallel to the rotary shaft 24 of the driving roller 21. For this reason, when the cylindrical driven rollers rotate with rotation of the driving roller 21, vibration due to the displacement of the rotary shafts may occur. Therefore, although the inclined cylindrical driven rollers can restrict the position of the medicine containers 15 as in the second embodiment, to restrict the position of the medicine containers 15 more reliably, it is desirable to use the conical driven rollers 22c and 22d as in the second embodiment.

As long as the pressing rollers 19a and 19b are diagonally arranged, or the driven rollers 22a and 22b are conical, the medicine containers 15 are pressed toward the coupling plate 23b to restrict the position of the medicine containers 15, thereby preventing the medicine containers 15 from unnecessarily vibrating toward the rotary shafts 25a and 25b.

By diagonally arranging the pressing rollers 19a and 19b and making the driven rollers 22a and 22b conical, the medicine containers 15 can be prevented from unnecessarily vibrating toward the rotary shafts 25a and 25b more reliably.

(Modification Examples)

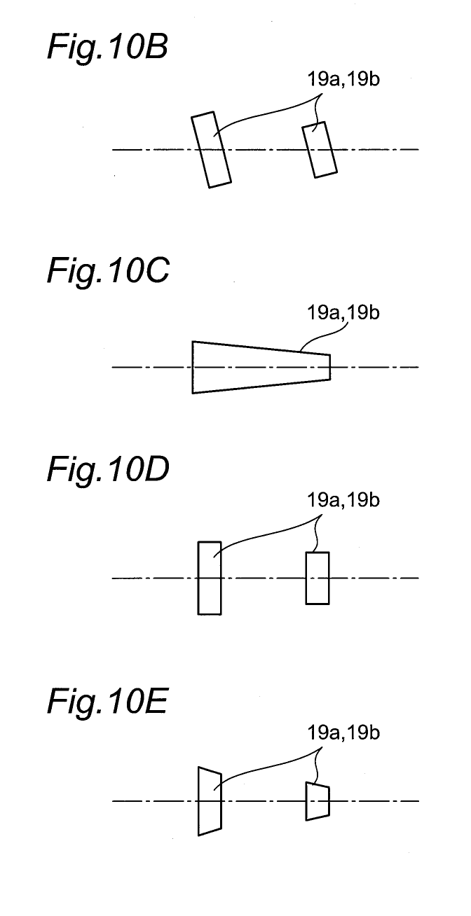

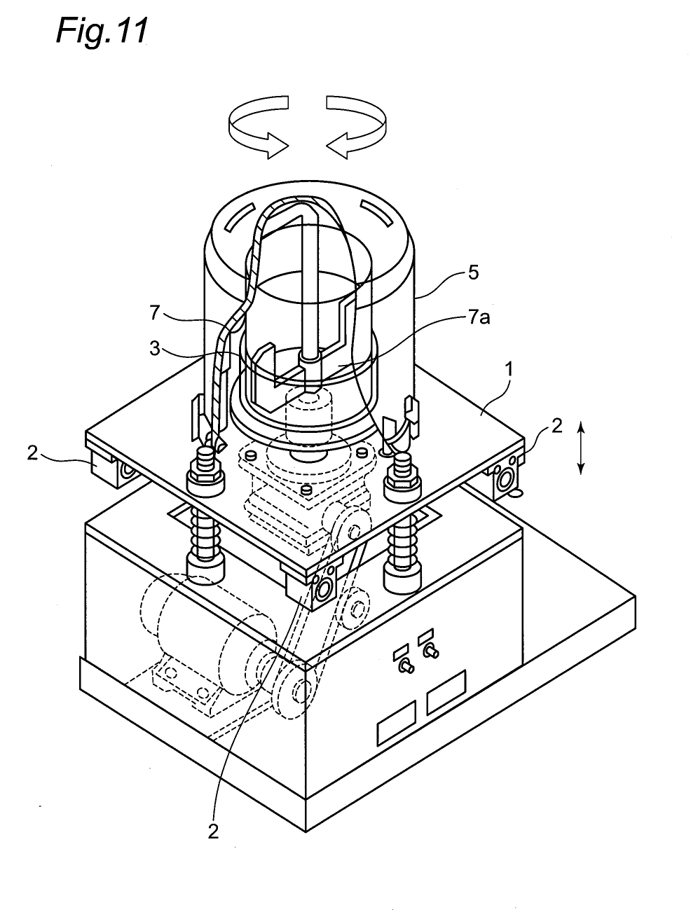

The pressing rollers 19a and 19b are not limited to the configuration as described above, and may be modified as follows. For example, as shown in FIG. 10A, each of the pressing rollers 19a and 19b are not limited to a pair of rollers, and may be a single diagonal roller.

As shown in FIG. 10B, the pressing rollers 19a and 19b may be formed of diagonal rollers of different diameters. In this case, it is desired that the diagonal roller having a larger diameter is arranged on the side of the lid-side coupling plate 23a.

As shown in FIG. 10C, each of the pressing rollers 19a and 19b may be formed of one conical roller of the outer diameter that becomes larger toward the lid of the medicine container 15 and becomes smaller toward the bottom of the medicine container 15. In this case, it is no need to diagonally arrange the conical roller in particular.

As shown in FIG. 10D, the pressing rollers 19a and 19b may be formed of two types of rollers of different diameters. In this case, it is necessary to arrange the roller having the larger diameter on the side of the lid-side coupling plate 23a. In this case, it is no need to diagonally arrange each roller in particular.

As shown in FIG. 10E, the pressing rollers 19a and 19b may be formed of two types of frustum rollers of different diameters. In this case, it is desirable to arrange the frustum roller having the larger diameter on the side of the lid-side coupling plate 23a. In this case, it is no need to diagonally arrange each roller in particular.

By properly combining the arbitrary embodiment (s) or modification (s) of the aforementioned various embodiments and modifications, the effects possessed by the embodiment (s) or modification (s) can be produced.

The medicine stirring apparatus and the medicine stirring method according to the present invention can stir medicines in the medicine container without foaming the medicines and therefore, are effective in hospitals and the like.

Although the present invention has been fully described in connection with the embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A medicine stirring apparatus comprising:
a container support section supporting a medicine container;
a rotational driving section rotating the medicine container supported by the container support section around a central axis of the medicine container via the container support section;
a vibration driving section reciprocal vibrating the medicine container supported by the container support section along the central axis of the medicine container via the container support section;
a pressing roller arranged opposed to the container support section, the pressing roller pressing the medicine container across the medicine container between the pressing roller and the container support section; and
a control part independently controlling driving of the rotational driving section and the vibration driving section, wherein
the pressing roller is diagonally arranged with respect to the central axis of the medicine container supported by the container support section.

2. The medicine stirring apparatus according to claim 1, wherein
a rotary axis of the pressing roller is diagonal with respect to the central axis of the medicine container supported by the container support section, and the pressing roller is diagonally arranged closer to a bottom of the medicine container in a rotational direction of the medicine container.

3. The medicine stirring apparatus according to claim 1, wherein
at least two pressing rollers are arranged for the medicine container supported by the container support section.

4. The medicine stirring apparatus according to claim 1, wherein
the pressing roller is biased by a biasing member toward the container support section.

5. The medicine stirring apparatus according to claim 1, wherein
the container support section includes a columnar driving roller and a cylindrical driven roller, and
a central axis of the driving roller is arranged parallel to a central axis of the driven roller.

6. The medicine stirring apparatus according to claim 1, wherein
the container support section includes a cylindrical driving roller and a conical driven roller, and
the driven roller is shaped like a conical shape having an outer diameter that becomes smaller toward a bottom of the medicine container supported by the container support section.

7. The medicine stirring apparatus according to claim 1, wherein
the rotating mechanism is coupled to the vibrating mechanism with a pair of coupling plates, and
the coupling plate arranged on a lid side of the medicine container supported by the container support section has a concave part for providing a gap between the coupling plate and a lid of the medicine container.

8. The medicine stirring apparatus according to claim 1, wherein
the rotating mechanism is coupled to the vibrating mechanism with a pair of coupling plates, and
the coupling plate arranged on a bottom side of the medicine container supported by the container support section has a rotational roller.

9. The medicine stirring apparatus according to claim 8, wherein
a rotary axis of the rotational roller is orthogonal to a rotary axis of the driven roller constituting the container support section.

10. The medicine stirring apparatus according to claim 1, wherein
the container support section is comprised such that the central axis of the medicine container supported by the container support section horizontally extends.

11. The medicine stirring apparatus according to claim 1, further comprising an illumination unit irradiating the medicine container supported by the container support section with light.

12. A medicine stirring method comprising:
rotating a medicine container around a central axis of the medicine container with a rotational driving section via a container support section under control of a control part with the medicine container sandwiched between the container support section and a diagonally-arranged pressing roller; and
reciprocatingly vibrating the medicine container along the central axis with a vibration driving section via the container support section.
